(19) United States
(12) Patent Application Publication
(10) Pub. No.: US 2011/0139855 A1
(43) Pub. Date: Jun. 16, 2011

(54) RESIDUAL OXYGEN MEASUREMENT AND CONTROL IN WAVE SOLDERING PROCESS

(76) Inventor: Tero RISTOLAINEN, Espoo (FI)

(21) Appl. No.: 12/639,126

(22) Filed: Dec. 16, 2009

(51) Int. Cl. B23K 37/00; B23K 1/08; B23K 3/06; B23K 31/12; B23K 31/02

(52) U.S. Cl. 228/102; 228/37; 228/259; 228/103

(57) ABSTRACT

Methods and apparatus for improving wave soldering processes by measuring and controlling the amount of residual oxygen present in the soldering tank and thereby avoiding excess dross formation. The methods and apparatus utilize a glass plate with ports to support sensors, e.g. oxygen sensors to both protect the solder bath from contact with air and to measure the oxygen levels associated with the solder bath.

### FIELD OF THE INVENTION

The present invention relates to improvements to wave soldering methods and particularly to methods of measuring and controlling the amount of residual oxygen present during a wave soldering process.

### BACKGROUND OF THE INVENTION

Wave soldering is a widely used process for large-scale soldering of electronic components to printed circuit boards (PCB). The name “wave soldering” comes from the use of waves of molten solder to attach the metal electronic components to the PCB. In practice, a tank is used to hold the molten solder, the components are inserted into or placed upon the PCB and then the assembly is introduced to the tank of molten solder and passes across a pumped wave of the solder. In this way the solder wets the exposed metallic areas of the PCB and creates a mechanical solder bond between the component and PCB as well as the electrical connection there between. Wave soldering is advantageous because it is a much faster process and provides higher quality bonds than manual soldering.

There are many types of wave soldering apparatus, but the basic components and operation is the same for all of them. In particular, a wave soldering machine generally includes three zones; the preheat zone, the fluxing zone and the soldering zone. An optional fourth zone, the cleaning zone is present in some wave soldering machines, depending on the type of flux that is used. A conveyor is used to the move the PCB through the different zones. The preheating zone is usually comprised of a heating means such as a heating pad, while the fluxing zone is equipped with a spray device to apply the flux to the PCB. The soldering zone comprises a pan to hold the solder, and a pump to produce the solder wave.

Preheating can be accomplished in the preheating zone by using convection heaters that blow hot air onto the PCB to obtain the desired processing temperature. An upper infrared heater may also be used when the PCB is densely packed. Preheating activates the flux and removes carrier solvents, while also preventing thermal shock that might occur when the PCB is exposed to the high temperature solder.

Flux is applied to the underside of the PCB in the fluxing zone. Two different types of fluxers are used, a spray fluxer and a foam fluxer. A spray fluxer sprays a fine mist of flux onto the bottom surface of the PCB usually from a spray arm that moves back and forth below the PCB, although other systems are known, such as, a stationary sprayer with a series of nozzles and stationary or oscillating ultrasonic heads. A foam fluxer is generally a tank of flux having a porous plastic cylinder (the “stone”) immersed therein. Air passes through the cylinder and creates a cascading head of flux foam. The PCB contacts this foam in order to be coated with flux. The precise control of the amount of flux applied is important as too little flux causes poor bonding and too much flux can create cosmetic and other problems.

Soldering takes place in the soldering zone. The pump in the tank of molten solder creates a standing wave (sometimes an intermittent wave) of solder on the molten surface. As the PCB progresses through the solder tank, the solder wave contacts the bottom of the PCB and adheres to solder pads and component leads to form the mechanical and electrical bonds. Precise control of the wave height is required to ensure application to the areas desired and to avoid splashing onto the top surface of the PCB.

One problem associated with wave soldering processes is the oxidation of the solder that creates solder dross. The dross forms when the solder contacts air in the system, wherein the rate of dross generation is dependent on the temperature and agitation of the solder. The presence of dross can reduce bond effectiveness and quality. Therefore, the reduction or elimination of dross formation is a growing concern in the electronic component industry, particularly as lead solders are being replaced by more easily oxidized solders made up of tin/lead base compounds and lead free compounds.

There have been several proposed methods of controlling dross formation. For example, oil can be used to reduce contact between the solder and air, but the oil must be changed frequently, is messy and may present environmental issues related to disposal. Wax can be added to the solder to form a surface blanket preventing oxidation. While not as messy as oil, wax must also be changed frequently and presents its own environmental concerns related to disposal. Marbles are sometimes floated on top of the solder to reduce the surface area of the solder in contact with air. However, marbles are not as effective as oil or wax. Nitrogen gas blankets are often used to prevent contact between air or oxygen and the solder in the soldering zone of the wave soldering system.

There remains a need in the art for improvements to wave soldering methods and apparatus and particularly to the reduction or elimination of dross formation.

### SUMMARY OF THE INVENTION

The present invention provides methods and apparatus for improving wave soldering processes. In particular the present invention provides methods and apparatus wherein oxygen levels in the soldering zone of a wave soldering operation can be measured and adjusted to improve the wave soldering results.

### BRIEF DESCRIPTION OF THE DRAWINGS

FIG. 1 is a schematic drawing of a wave soldering apparatus in accordance with an embodiment of the present invention.

FIG. 2 is a detailed plan drawing of the soldering zone of a wave soldering apparatus in accordance with an embodiment of the present invention.

### DETAILED DESCRIPTION OF THE INVENTION

The present invention provides improved wave soldering methods and apparatus wherein the disadvantages of excess dross formation are overcome. In particular, the present invention provides methods and apparatus wherein oxygen levels in the soldering zone of a wave soldering operation can be measured and adjusted to improve the wave soldering results and reduce dross formation.

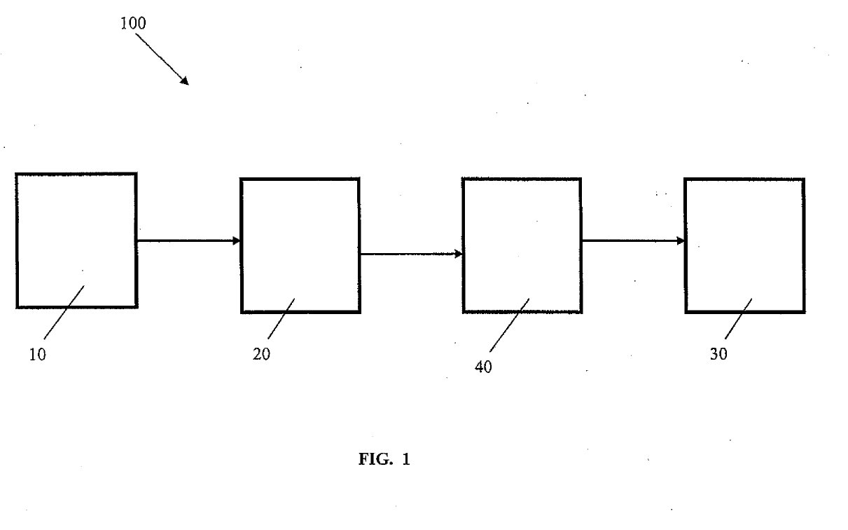

The present invention will be described with reference to FIG. 1 which is a schematic drawing of a wave soldering apparatus according to the present invention. In particular, FIG. 1 shows a wave soldering system 100, comprising a preheat zone 10, a flux zone 20 and an optional cleaning zone 30, all of which are standard and conventional for wave soldering apparatus. The system 100 also includes a soldering zone 40 that is designed in accordance with the present invention to allow for the measurement and control of oxygen levels before, during and after the soldering operation and the reduction of dross formation.

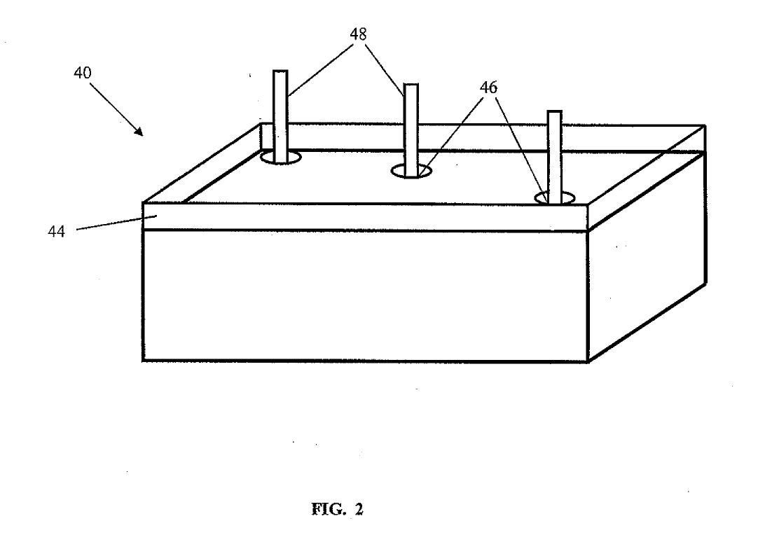

FIG. 2 is a detailed plan view of the solder zone 40 according to the present invention, comprising a solder tank 42, and a transparent glass plate cover 44, having ports 46, for sensors 48. In operation a PCB with components to be soldered passes into the solder zone 40 and is soldered using standard solder wave techniques. The difference is the utilization of glass plate 44 that that can protect the solder from contact with air thereby reducing oxidation of the as solder (e.g. reducing dross formation). The main purpose of the glass plate 44 is to allow for the measurement of residual oxygen levels in the system 100 so that such measurements can be used to control nitrogen flow and pressure to the system 100 or soldering zone 40 to reduce the amount of residual oxygen present. To accomplish these measurements, glass plate 40 has ports 46 that accommodate sensors 48 capable of measuring residual oxygen levels in the solder tank 42.

The glass plate 44 manufactured to fit the conveyor of the system 100 and is typically about 6 mm thick and 250 mm square. However, the glass plate 44 can of any size appropriate for the conveyor belt of other components of the system 100 being used. The glass plate 44. By fitting the glass plate 44 to the conveyor belt, the glass plate 44 can be driven through the system 100, or alternatively only through the solder zone 40, and avoids blocking of the PCBs being soldered. The glass plate 44 should be pre-stressed in order to withstand the temperature variations of the solder bath, which can typically range from 0° C. to 360° C.

As noted, the glass plate 44 is provided with ports 46 for accommodating sensors 48. The ports 46 are formed by etching or drilling through the glass plate 44 prior to annealing of the glass plate 44. Any number of ports 46 and sensors 48 can be provided, as long as the structural integrity of the glass plate 44 is not affected. However, three ports 46 accommodating three sensors 48 in which case one sensor 48 will be located near each edge of the glass plate 44 and the third sensor will be located in a central position of glass plate 44.

In operation, the sensors 48 are oxygen sensors and are used to take measurements of residual oxygen present above the solder bath. In particular, measurements are first taken when the solder bath is in an idle state, i.e. at a time when the solder is hot but no PCBs are being treated and no wave is being formed in the solder bath. Because the hot solder reacts with the oxygen in the air, it is important to block air from the solder bath during this idle state to prevent formation of dross. A nitrogen gas flow is used to blanket the idle solder bath and prevent interaction with the air (and particularly with oxygen in the air). Having the glass plate 44 in place above the solder tank 42 during this stage helps to black air from the solder bath, but the plate 44 is primarily used for holding the sensors to take residual oxygen measurements at this stage.

Further residual oxygen measurements are taken during the soldering process. This measurement can be done in either a tunnel type of wave soldering system or in a wave soldering system having a nitrogen hood for the soldering tank, that are the two predominant types of wave soldering systems currently employed. In a tunnel type system, nitrogen is fed throughout the entire length of the system 100, while in nitrogen hood type of system, the nitrogen is provided only in the solder zone 40. Measurements of residual oxygen are taken using the glass plate 44 and sensors 48 according to the present invention and are used to optimize the use of nitrogen flow. In particular, in a tunnel type system, the measurement data provides a reading of the entire system 100 and provides a means for determining where nitrogen flow is too low or too excessive. In a hooded system, the measurement data is used to determine how well the nitrogen blanket is working. In either case, using the measurements obtained by using the glass plate 44 and sensors 48 of the invention, allows for optimization of the nitrogen flows and pressures to the system 100.

By taking reading during the solder bath idle time and during soldering operations, reliable and accurate determinations of the residual oxygen levels at different operation times are obtained, including the time when PCBs enter the solder zone, the time when the PCBs are being soldered in the solder zone, and the time when the PCBs exit the solder zone. These measurements are facilitated by the placement of the preferred three sensors 48, two at the edges of the glass plate 44 and the third in the center area of the glass plate 44. As noted the measurements obtained provide the means to optimize the nitrogen flows and pressures to different areas of the wave soldering process.

By using the apparatus and methods of the present invention the wave soldering operation can be stabilized and optimized. Measurements may be necessary as little as one to two times a year but can be carried out as often as desired to maintain stability and repeatability of the wave soldering operation. The data obtained by using the apparatus and methods of the invention give operators of wave soldering machines better knowledge of their operation and higher quality assurance. In addition, by using the measurement data and optimizing the nitrogen flows, better overall quality of the soldering process is possible. In particular, it is preferred to reduce residual oxygen levels to less than 500 ppm by increasing the amount of nitrogen provided to the system, especially when using lead free solders.

By using the soldering zone having a glass plate and sensors in accordance with the present invention, several advantages are achieved. In particular, residual oxygen can be measured and monitored to optimize soldering conditions and particularly control the formation of dross. This in turn provides much higher quality of the solder bonds for the PCBs. By optimizing the amount of nitrogen used during heating, soldering and cooling phases of the wave soldering process in order to control the residual oxygen levels in the system, fewer short circuits occur and therefore more reliable products are produced at higher yields. This is particularly important with the current changes to lead free solders and the use of only organic solderability preservatives (OSP) on the copper layers of the PCBs.

Another advantage of the present invention is that the transparent glass plate allows for visible inspection of the entire soldering process by technicians which allows for greater control and consistency of the wave soldering process. In addition, the use of a transparent glass plate prevents contact of the sensors with the solder bath which would destroy them.

Further, it is possible to monitor other conditions of the soldering process than the oxygen levels. In particular, measurements of carbon monoxide, carbon dioxide and methane can be made to help control the process. In addition, temperature can be precisely measured which can reveal the exact point where flux vapors burn off during the soldering process and thus lead to further optimization of the wave soldering operation.

As described above, the measurements obtained by the apparatus of the invention are gathered and then used to adjust operation parameters. Alternatively, the apparatus of the invention can be directly connected to the wave soldering operation control system for automatic adjustment of the nitrogen flows and pressures to control the residual oxygen.

It will be understood that the embodiments described herein are merely exemplary and that one skilled in the art may make variations and modifications without departing from the spirit and scope of the present invention. All such variations and modifications are intended to be included within the scope of the invention as described above. Further, all embodiments disclosed are not necessarily in the alternative, as various embodiments of the invention may be combined to provide the desired result.

What is claimed is:

1. In a wave soldering system having a soldering zone protected from interaction with air or residual oxygen by providing nitrogen gas over the surface of solder in the soldering zone, a method maintaining the amount of residual oxygen in the soldering zone below a predetermined level comprising:
measuring the amount of residual oxygen present in the wave soldering zone; and
adjusting the flow and pressure of the nitrogen gas to maintain the amount of residual oxygen below the predetermined level.

2. A method according to claim 1 wherein the wave soldering system is a tunnel type of wave soldering system.

3. A method according to claim 1 wherein the wave soldering system includes a nitrogen hood for the soldering zone.

4. A method according to claim 1 wherein the wave soldering system uses lead/tin based solder or lead-free solder.

5. A method according to claim 1 wherein measuring the amount of residual oxygen comprises taking measurements of the residual oxygen during different stages of the wave soldering process including at a time when the soldering zone is in idle mode and at a time when a soldering process is being performed.

6. A method according to claim 1 wherein the predetermined level is 500 ppm.

7. A method according to claim 1 wherein the measurements or residual oxygen are provided directly to a control center for the wave soldering system to allow for real time adjustment of nitrogen flows and pressures.

8. A method of preventing dross formation in a wave soldering system having a soldering zone protected from interaction with air or residual oxygen by providing nitrogen gas over the surface of solder in the soldering zone, the method comprising:
measuring the amount of residual oxygen present in the wave soldering zone; and
adjusting the flow and pressure of the nitrogen gas to reduce residual oxygen levels below a predetermined level and thereby prevent dross formation.

9. A method according to claim 8 wherein the wave soldering system is a tunnel type of wave soldering system.

10. A method according to claim 8 wherein the wave soldering system includes a nitrogen hood for the soldering zone.

11. A method according to claim 8 wherein the wave soldering system uses lead/tin based solder or lead-free solder.

12. A method according to claim 8 wherein measuring the amount of residual oxygen comprises taking measurements of the residual oxygen during different stages of the wave soldering process including at a time when the soldering zone is in idle mode and at a time when a soldering process is being performed.

13. A method according to claim 8 wherein the predetermined level is 500 ppm.

14. A method according to claim 8 wherein the measurements or residual oxygen are provided directly to a control center for the wave soldering system to allow for real time adjustment of nitrogen flows and pressures.

15. An apparatus comprising a glass plate sized to fit the conveyor component of a wave soldering system and having at least one port formed therethrough to accommodate at least one sensor.

16. An apparatus according to claim 15 wherein the glass plate is pre-stressed to withstand temperatures ranging from 0° C. to 360° C.

17. An apparatus according to claim 15 having at least three ports each accommodating a sensor.

18. An apparatus according to claim 17 wherein one port is located near a first edge of the glass plate, a second port is located near a second edge of the glass plate opposite the first port, and the third port is located at or near the center of the glass plate.

19. An apparatus according to claim 15 wherein the sensor is an oxygen sensor, a carbon monoxide sensor, a carbon dioxide sensor, a methane sensor or a temperature sensor.
